(19) United States
(12) Patent Application Publication
(10) Pub. No.: US 2020/0062174 A1
(43) Pub. Date: Feb. 27, 2020

(54) Method And Device For A Vehicle-External Display For A Vehicle, And/Or For Adapting The Vehicle-External Visual Appearance Of The Vehicle

(71) Applicant: Volkswagen Aktiengesellschaft, Wolfsburg (DE)

(72) Inventors: Christian Reimker, Braunschweig (DE); Alessandro Conte, Wolfsburg (DE); Jonas Seidler, Wolfsburg (DE); Matthias Liesegang, Berlin (DE); Stefan Enneking, Wolfsburg (DE); Daniela Krefter, Wolfsburg (DE)

(73) Assignee: Volkswagen Aktiengesellschaft, Wolfsburg (DE)

(21) Appl. No.: 16/548,015

(22) Filed: Aug. 22, 2019

(30) Foreign Application Priority Data
Aug. 23, 2018 (DE) 10 2018 214 309.9

(51) Int. Cl. B60Q 1/50; G09F 21/04; G09F 9/33

(52) U.S. Cl. CPC B60Q 1/503; G09F 9/33; G09F 21/048

(57) ABSTRACT

A method is provided for a vehicle-external display for a vehicle, and/or for adapting the external visual appearance of the vehicle, data for the vehicle-external display and/or the adaptation of the vehicle-external visual appearance are generated in the vehicle or received by the vehicle. By means of the generated or received data, an individual adaptation is carried out of the vehicle-external visual appearance and/or an individualized vehicle-external display of the data. In this case, the vehicle-external display of the data can be accomplished by means of an electronically controlled display unit that is integrated in the outer skin of the vehicle, or is a part of the outer skin of the vehicle, or is designed as an external lighting element.

### CROSS-REFERENCE TO RELATED APPLICATIONS

This application claims priority to German Patent Application No. DE 10 2018 214 309.9, filed on Aug. 23, 2018 with the German Patent and Trademark Office. The contents of the aforesaid Patent Application are incorporated herein for all purposes.

### TECHNICAL FIELD

The present invention relates to a method for a vehicle-external display for a vehicle, and/or for adapting the vehicle-external visual appearance of the vehicle. The present invention furthermore relates to a device for a vehicle-external display for a vehicle, and/or for adapting the vehicle-external appearance of the vehicle, and a motor vehicle that is configured to execute such a method, or has such a device.

### BACKGROUND

Frequently information such as advertising slogans is on the outside of motor vehicles. For this, lettering and graphic illustrations can already be incorporated in the paint, or placed on the paint using appropriate stickers or films. With trucks in particular, such information is also reproduced on tarpaulins on the truck. The disadvantage of this method however is that the shown information cannot be exchanged or updated without significant effort.

Although tarpaulins with printed advertising are normally removably fastened to the vehicle and thus enable a mechanical exchange as for example described in EP 1 376 518 A2, the changeability of the shown information then remains restricted since the image content of the respective tarpaulin cannot be changed.

Such a flexible adaptation is possible with the cab vacuum sweeper disclosed in DE 20 2010 012 727 U1. This can be used as a mobile advertising platform in that digital displays can be fastened to the outside on the front and side walls of the cab vacuum sweeper in order to thus create a mobile advertising platform. Given their suspension device and quick-lock cabling, the digital displays are easy to mount and remove. However this can result in an elevated risk of theft, for example with an unoccupied vehicle.

Moreover, EP 3 048 599 A1 discloses a display of data by means of a display located on the outer side surface of a motor vehicle. To accomplish this, the current position and current orientation of the side surface is ascertained. The data are selected depending on the current position of the vehicle and current orientation of the side surface, and the selected data are displayed on the side surface of the vehicle so that they are visible from the outside to an observer of the vehicle.

### SUMMARY

An object exists to provide an improved method and an improved device for external advertising by a vehicle, and/or for adapting the vehicle-external visual appearance of the vehicle.

This object is solved by a method and a corresponding device according to the independent claims. Embodiments are apparent from the following description and the dependent claims.

In one aspect, a method is provided for a vehicle-external display for a vehicle, and/or for adapting a vehicle-external visual appearance of the vehicle. According to the method, data for the vehicle-external display and/or the adaptation of the vehicle-external visual appearance are generated in the vehicle or received by the vehicle. Using the generated or received data, an individual adaptation is carried out of the vehicle-external visual appearance and/or an individualized vehicle-external display of the data.

In another aspect, a device for a vehicle-external display for a vehicle, and/or for adapting the vehicle-external visual appearance of the vehicle is provided. The device comprises:
a generating unit for generating data for the vehicle-external display and/or the adaptation of the vehicle-external visual appearance within the vehicle, or a receiver unit for receiving the data; and
a control unit that is fed the generated or received data, wherein the control unit is configured to initiate an individualized adaptation of the vehicle-external visual appearance and/or an individualized vehicle-external display of the data.

The details of one or more embodiments are set forth in the accompanying drawings and the description below. Other features will be apparent from the description, drawings, and from the claims.

### BRIEF DESCRIPTION OF THE DRAWINGS

In the FIGS.:

FIG. 1 schematically portrays a flowchart of a first embodiment;

FIG. 2 schematically portrays a flowchart of a second embodiment; and

FIG. 3 portrays an example of a use of the second embodiment;

and

FIG. 4 schematically portrays a block diagram of a device.

### DETAILED DESCRIPTION

Specific embodiments of the invention are here described in detail, below. In the following description of embodiments of the invention, the specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

As discussed in the preceding and in one aspect, a method is provided for a vehicle-external display for a vehicle, and/or for adapting a vehicle-external visual appearance of the vehicle. According to the method, data for the vehicle-external display and/or the adaptation of the vehicle-external visual appearance are generated in the vehicle or received by the vehicle. Using the generated or received data, an individual adaptation is carried out of the vehicle-external visual appearance and/or an individualized vehicle-external display of the data.

The vehicle-external display of the data may for example be accomplished by means of an electronically controlled display unit that is integrated in the outer skin of the vehicle, or is a part of the outer skin of the vehicle, or is designed as an external lighting element.

In some embodiments, the stopping of the vehicle is detected, and then the display unit of the motor vehicle is adapted for showing vehicle-external data. The activated display unit may show vehicle-external data for example when it is detected that the vehicle is in a parked state. In this manner, display units for example that, while driving, carry out a function relevant to driving can be used accordingly for a temporary display of data unrelated to the vehicle, such as advertising content.

For example, headlamps or lights of the vehicle in a parked state can be used for advertisements. Accordingly and for example, the individual LED elements can be specifically controlled in LED headlamps or rear lights with numerous LED elements and individually illuminated in order to show a graphic themselves that can be perceived when looking at the headlamps or lights. Likewise with LED headlamps that enable a pixel-based lighting of the surroundings in front of the vehicle, image content can be projected onto the road surface, a wall, or other surfaces in front of or adjacent to the vehicle. Likewise with automatically driving vehicles, the current driving mode can be signaled while driving by means of the same external display unit, and advertisements can also be displayed in a stationary, or respectively parked state.

In some embodiments, the vehicle is an autonomously driving vehicle, wherein at least part of the outer skin of the vehicle is adapted when the autonomously driving vehicle is requested by at least one future passenger for a transport service. This makes it easier or possible for the at least one future passenger to recognize the requested vehicle.

In some embodiments, an individualized design of the outer skin of the vehicle is generated within the vehicle by means of a computer platform or is received by the vehicle, and the outer skin of the vehicle is correspondingly adapted to the individualized design.

In some embodiments, advertising content is reproduced by adapting the vehicle-external visual appearance, and/or the vehicle-external display, wherein a parameter is output by the vehicle for the advertising content that has actually been reproduced for a payment system for the reproduction of advertising content. Such a parameter can then be used to settle up with the advertiser. This can for example ensure that a payment is only made when the advertising content has been actually reproduced by the vehicle. Likewise, the parameters can also contain other information, for example about the duration of the reproduction, the time of day, or the location of reproduction that then can be used to calculate the amount of the fee to be paid.

Likewise with a vehicle that is driven by electrical energy provided by a battery, advertising content may, in some embodiments, be reproduced while charging the battery. In this manner, it is ensured that sufficient energy is available for reproducing the advertising content. This also makes it possible for example for the cost of energy consumption to reproduce the advertising content to be borne directly by the advertiser but not by the vehicle user.

According to a second aspect, a device for a vehicle-external display for a vehicle, and/or for adapting the vehicle-external visual appearance of the vehicle comprises:
a generating unit for generating data for the vehicle-external display and/or the adaptation of the vehicle-external visual appearance within the vehicle, or a receiver unit for receiving the data; and
a control unit that is fed the generated or received data, wherein the control unit is configured to initiate an individualized adaptation of the vehicle-external visual appearance and/or an individualized vehicle-external display of the data.

In some embodiments, the device according to the present aspect is configured according to one or more of the embodiments, discussed in the preceding with respect to the preceding aspect. With respect to the terms used and their definitions, reference is made to the preceding aspect.

According to further aspects, a motor vehicle is provided in which an embodiment of the method according to the first aspect, or an embodiment of the device according to the second aspect, is used.

Additional features of the present invention can be found in the following description and the claims in conjunction with the figures.

In order to better understand the principles of the present disclosure, further embodiments are explained in greater detail below based on the FIGS. Of course, the invention is not limited to these embodiments, and the described features can also be combined or modified without departing from the invention's scope as defined in the claims.

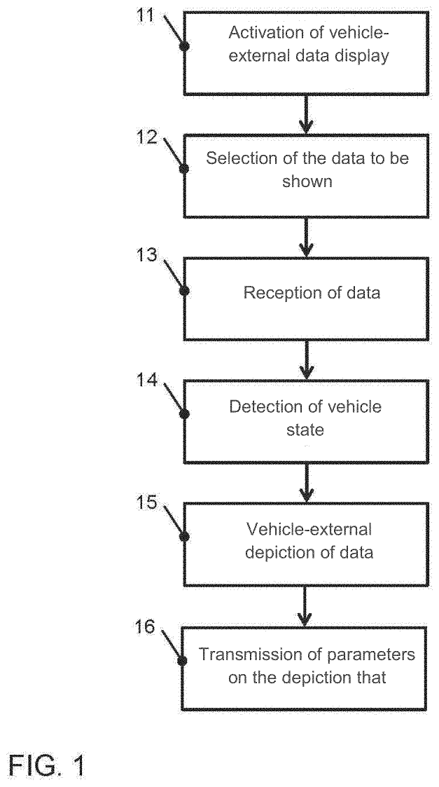

FIG. 1 schematically portrays a flowchart for a first embodiment of the method in which the display units, in particular of parked vehicles can be used for the vehicle-external depiction of advertising content, or other data as well.

According to method step 11, a vehicle-external display is first enabled by a vehicle user. In this case, the data to be shown can be any personalized content, in particular advertising content. The advertising content can in this case refer to a company, products or services of the user. Likewise, the displayed advertisement can also refer to third-party companies. In this case, it can be provided that a fee is paid to the user of the vehicle in recompense for the display of the advertising. If the activation is not initiated by the vehicle owner but rather by another vehicle user, it can first be checked during the activation as to whether the vehicle, or respectively the current user, is at all authorized by the vehicle owner for activation. Moreover, the vehicle state in which the vehicle-external reproduction of the data should occur can be determined by the user in the context of activation. It can accordingly be provided in particular that such a vehicle-external depiction should occur only for a stopped or parked vehicle. However, it can likewise be provided that the data are also displayed while the vehicle is driving to the extent that this is set forth in the context of the respective relevant ordinance, the rules for users of public roadways such as the motor vehicle code of the Federal Republic of Germany.

After the vehicle is activated, the data to be shown can be selected in method step 12. Accordingly, for example, the vehicle user can search a website of a company that is interested in portraying its company's advertising content, and selecting advertising content. It is likewise also conceivable for specialized Internet portals or online networks to provide advertising content from different companies for selection. It can also be provided that the user only releases his vehicles to show advertising content, but does not personally select any advertising elements to be displayed, however. This may then be done by a third-party such as for example a parking lot owner instead of the user.

Moreover, the user however can also select content not relating to advertising for a personalized depiction, for example from a publicly accessible or private collection of images or photographs or a video library available to the user.

In this case, social networks can also be accessed in which users of the social network share images, photographs or videos with other users, for example by pinning them to virtual billboards.

Finally, the shown content can also be selected depending on the current vehicle location in addition to or instead of the user selection. This can for example be determined by means of the GPS coordinates that are ascertained by a vehicle navigation device.

If a plurality of adjacent, or respectively sequential vehicles have been released by the respective user, the advertising elements can also extend across vehicles over the released vehicles. The advertising elements can also contain business names and point towards the entrance of the mentioned business in combination with a shown, possibly dynamic directional arrow. Likewise, a product name or logo can also be presented, and a shown directional arrow can point towards a business that carries the mentioned product. Instead of an advertising slogan, other informational content can be reproduced across vehicles. Accordingly a parking lot operator can for example display the shortest emergency exit depending on the location in an emergency. In this case, the GPS coordinates of the vehicles as well as the position data of the location to be targeted such as the business, the fire escape, or respectively the emergency exit can be evaluated in order to indicate the correct directional information with the directional arrow.

After the data to be shown are selected, they are received by the vehicle in method step 13. Accordingly for example the advertising content can be received directly from the advertiser via a wireless Internet link. Likewise, content unrelated to advertising for a personalized depiction can be received, for example from a mobile device of the user that is coupled to the vehicle for example by Bluetooth. The received data are then buffered in the vehicle for subsequent depiction. Instead of accessing buffered data, it can also be provided to establish a link between the vehicle and advertiser at the beginning of the parking process, or also during the parking process, and download the content to be shown, or to update the content in particular when the vehicle has been parked for a longer time. Likewise, it can also be provided that sensors of the vehicle detect people around the vehicle and ascertain information on each detected person, for example whether it is probably a woman, man or child, and carry out a personalization of the displayed advertising content based thereupon.

When the user specifies that a user-external reproduction of the data should only occur for certain vehicle states, the current vehicle state is detected in method step 14. For this, a wide range of suitable signals such as control signals from an engine and/or transmission control unit or an ESP control unit, as well as for example signals from one or more sensors of an inertial sensor system or other sensors can be evaluated.

The vehicle-external depiction of the data then occurs in method step 15. Instead of a static display of lettering, an individual graphic or an individual image or photograph, several such contents can be shown in this case at different times. Reproduction of video content is likewise also conceivable. Depending on the technology that is used to display the data, the display can be during the entire time of parking, or can also be shut off, however, once the danger exists that not enough energy remains, for example in the battery of the vehicle, for subsequently driving the vehicle. For this, the battery charge can be continuously monitored, and the display can be turned off when the battery charge threatens to drop too much for subsequent driving. Likewise, it can also be provided in this case that sensors of the vehicle detect people and/or other vehicles around the vehicle. If people and/or other vehicles are detected, the display is turned off. If people, or respectively other vehicles are no longer detected afterwards, the display can be turned off again so that energy for the display is not unnecessarily consumed.

Moreover when reproducing advertising content, a parameter on the actual reproduction of advertising content can be output by the vehicle in method step 16 depending on the advertising model, or respectively payment system. Such a parameter can then be used to settle up with the advertiser. This can for example ensure that a payment is only made when the advertising content has been actually reproduced by the vehicle. Likewise, the parameters can also contain other information, for example about the duration of the reproduction, the time of day, or the location of reproduction that then can be used to calculate the amount of the fee to be paid.

It can also be provided for people and/or other vehicles in the surroundings of the vehicle to be detected by one or more vehicle sensors while advertising and transmit information about this to the advertiser. In this manner, the number of persons reached by the advertisement can be readily estimated and taken into account for payment.

Likewise with an electric vehicle that displays advertising content on for example a charging column while charging the battery can output information on the reproduced advertising which can be evaluated in order to pass on the cost for energy consumption to reproduce the advertising content, or the cost for charging the battery to the advertiser in whole or in part.

The former described method can be performed using a computer application provided therefor which for example can be installed as a so-called app in the vehicle infotainment system and used by the user through said system. It can likewise be provided to execute parts of the method on a mobile user device such as a smart phone or tablet computer. Depending on the application, not all of the aforementioned method steps must be performed in this case. For example, method step 16 is recommendable for a display of advertising content, but not for a depiction of private images or photographs.

In addition to the chassis and body-in-white, the body structure of the vehicle has the so-called outer skin which consists of the visible surfaces of the vehicle, i.e., substantially the hoods, doors, roof, fenders and side parts. These normally consist of metal materials and in particular serve to protect the passengers or transported goods. However approaches have also been produced in the interim to integrate an electronic display directly in the outer skin of the vehicle, for example by means of special OLED films. According to some embodiments, such an electronically controlled outer skin of the vehicle can also be used for a vehicle-external depiction of data corresponding to the above-described method.

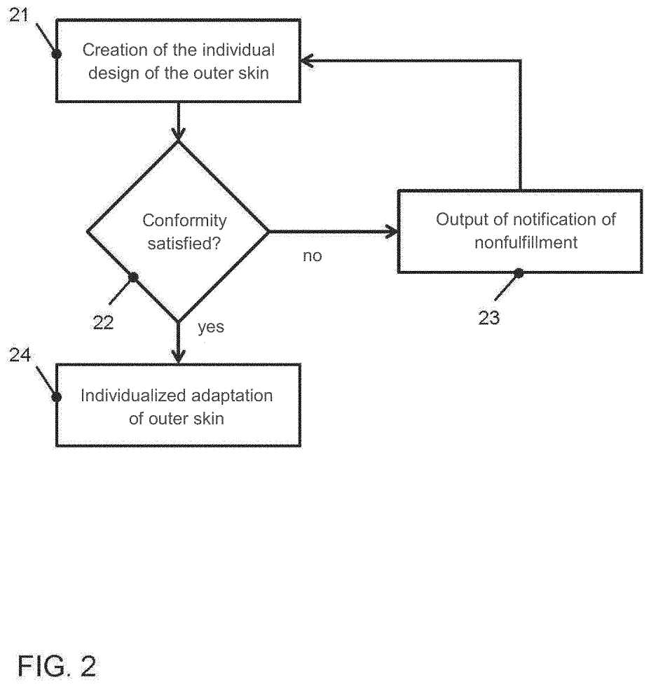

In addition or instead, partially transparent, semitransparent or fully transparent displays can be integrated in the window surfaces of the vehicle based on OLED technology, or respectively replace the normal window surfaces of the vehicle. Possibly for a fee, these could be turned on for passengers on the inside, or alternatively supplement the advertising space on the outside. It can likewise be provided to pay the user for turning off the displayed advertising and allowing him to see outside. An electronically controllable outer skin can however also be used to adapt the vehicle-external visual appearance of the vehicle, for example to make the vehicle identifiable for easier recognition, or to individualize the design. FIG. 2 schematically shows a flowchart of such a second embodiment.

According to method step 21, first a digital, individual visual appearance of the outer skin is designed using a computer platform. This can in particular be done by a user of the vehicle.

The user of the vehicle in this case can be a person who is currently using the vehicle, or the owner of the vehicle, for example if this person wants to individualize the external appearance of their vehicle to visually enhance it, or respectively distinguish it from other vehicles.

It can likewise also be a future vehicle user, however, who has requested the vehicle for conveying people in the future or transporting goods in the future. In this case, the recognition of the vehicle by the requesting person when meeting can be facilitated by an individual adaptation of the visual appearance of the outer skin.

In particular with autonomously driving vehicles that convey people as a shuttle and do not have a driver, recognition can be greatly simplified since the customer cannot talk with the driver when the vehicle arrives. Moreover, with a suitable selection of the individualization, this ensures reliable recognition without publicly passing on personal data in contrast to a vehicle-external display of the name of the respective customer.

In such a case, the requesting user still does not have access to the vehicle. Consequently, the design of the outer skin of the vehicle is individualized by means of a computer platform that the user for example accesses by means of a mobile terminal or a computer available to the user. This can be provided for example by the shuttle service that offers vehicles for conveying people, or a logistics company that offers transportation of goods. This can likewise also be done by a higher-level computer platform by means of which a plurality of such companies can be accessed.

For individualization, a plurality of different images, patterns and/or color designs can be specified, one of which can be selected by the future user. These can be abstract or for example also based on national colors, the colors and symbols of known sports associations, or IDs and logos of known companies. It is likewise possible for the selection to be made in such an instance not by the future user, but rather by the shuttle service, logistics company, or the higher-level computer platform.

It is furthermore conceivable that an independent image or pattern suitable for individualization is uploaded to the computer platform by the future user. For this, the user can access corresponding data that are saved on the device by which the user communicates with the computer platform, such as his cell phone. If a suitable image is unavailable, it can instead be generated during the request, for example in that the user takes a picture using the camera integrated in the cell phone and uploads it, or a suitable portion thereof, to the computer platform.

In particular if a specific picture or pattern is not accessed, there is a conformity test in method step 22 in order to check if the individualization generated by the user can be used on the outer skin. In this manner, it can for example be ensured that a design for the outer skin is not suggested for example that is used by public authorities or organizations such as the police or fire department for their vehicles. It can also thus be ensured that for example no images are selected that are distracting, irritating or offensive to other road users, or otherwise violate common decency. For this, an analysis can for example be performed by the server on which the computer platform is installed of the lettering, image or pattern created by the user, or respectively a comparison with image content and patterns that are defined as impermissible in the database.

If it is determined in a conformity test that the individualization of the outer skin generated by the user violates the conformity requirements, it will not be applied on the outer skin of the vehicle. In method step 23, a corresponding message can then be output to the user, possibly with additional information on why the conformity requirements are not met, or how the lettering, or respectively the image or pattern should be changed in order to satisfy the conformity requirement. The output can in this case be done for example using a display on a graphic user interface, or a voice output. Subsequently, the method can then return to method step 21 in order to give the user the option of drafting a suitably amended variation of the outer skin.

If in contrast the conformity requirements are met in the conformity test, the individualized adaptation of the outer skin of the vehicle then occurs in method step 24. In this case if the conformity test is passed, it can also be provided that a preview is first displayed in the form of a model of the vehicle with an individually adapted outer skin, for example on the display of the cell phone of the user. This makes it possible for the user to terminate the adaptation of the outer skin if it does not correspond to his wishes. Likewise when requesting a vehicle, a display of the model can further simplify identification since the appearance of the arriving vehicle can be compared with the appearance of the shown model when the requested vehicle arrives.

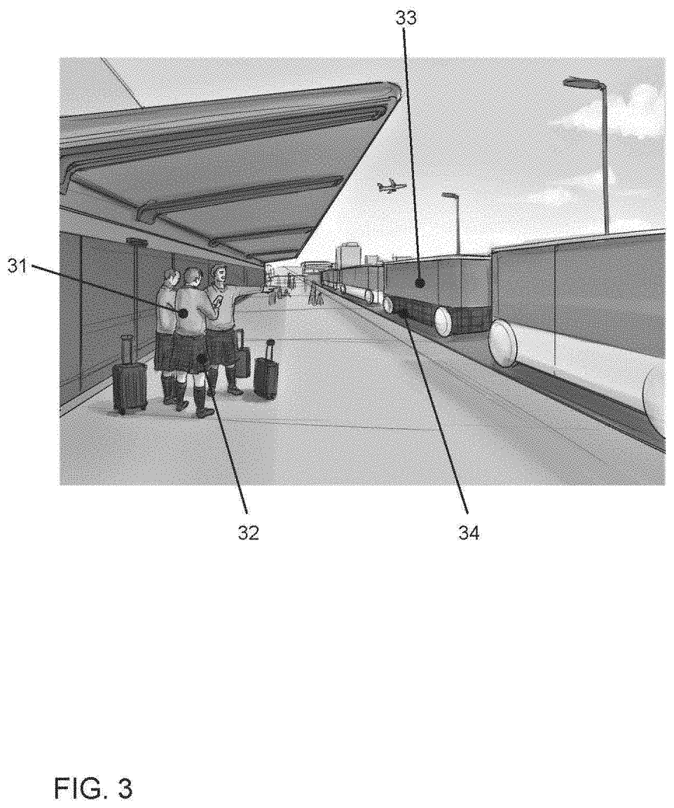

An example of a use of the method for identifying a requested shuttle for conveying people is shown in FIG. 3. In this example, a group of people 31 are outside of an airport terminal and are waiting for a shuttle vehicle that they requested with a cell phone. The people in the group of people 31 are each wearing leg wear 32 with plaid material. The requested shuttle vehicle 33 approaches the group of people. In order to facilitate recognition by the people in the group of people, the bottom part of the outer skin 34 of the shuttle vehicle 33 is designed corresponding to the leg wear design.

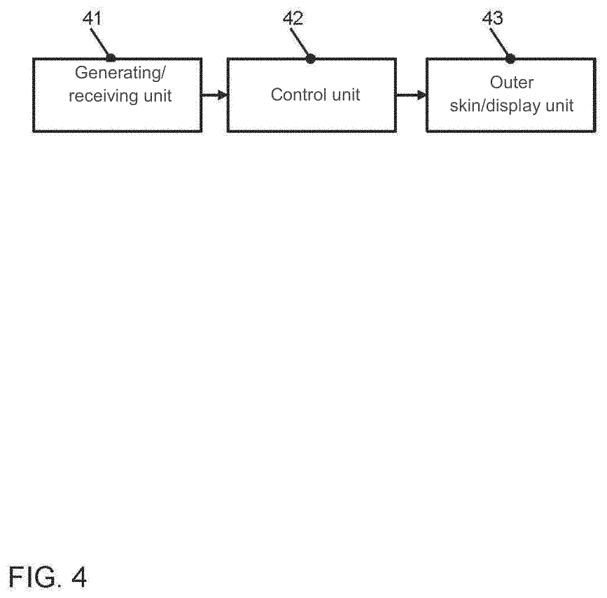

FIG. 4 schematically portrays a block diagram of an embodiment of a device. The data for the vehicle-external display and/or the adaptation of the vehicle-external visual appearance are generated or received by a generating/receiving unit 41. The generating/receiving unit 41 in this case can contain a user interface (not shown) by means of which the user can generate entries to release and select data for the vehicle-external display, or respectively for adapting the vehicle-external visual appearance. Likewise, the generating/receiving unit 41 can have a communication unit (not shown) with which already generated data can be received. In particular, the communication unit in this case can receive the data wirelessly, for example by means of a mobile communications data standard, WLAN or Bluetooth. The generated or received data are fed to a control unit 42. Likewise, the control unit 42 can be fed information on the current vehicle state, sensor data on the vehicle surroundings, or on the position of the vehicle. Corresponding to this data, the control unit 42 then controls an externally affixed display unit, or respectively the outer skin of the vehicle. Likewise, the control unit, in particular in the reproduction of advertising contents, can ascertain parameters on the depiction and possibly output them via the aforementioned communication unit.

The externally affixed display unit 43 can for example be an LCD or OLED display, or an LED panel as well with a plurality of individual LEDs. Likewise a passive, i.e., non-illuminated display unit such as a so-called E-paper display can also be used. An E-paper display has the advantage that it reflects light contacting the display like normal paper and thereby enables a permanent display without a maintenance voltage being required for this. Therefore energy only has to be used when the display is to be changed at a later time. Likewise, headlamp systems or lights that enable a pixel-based depiction can be used for a vehicle-external display by means of projecting the digital content, for example on the ground in front of or in back of the vehicle, or on walls located there. Such pixel headlamps with several thousand individually controllable points of light are already available; higher resolutions of more than 2 million pixels are being tested.

The outer skin can for example be individualized by means of OLED films integrated in the outer skin. By suitable controlling, content can then be shown directly by means of the outer skin of the vehicle. Likewise, partially transparent, semitransparent or fully transparent displays, for example also based on OLED technology, can also be integrated in window surfaces of the vehicle.

Finally, one or more video projectors, with which stationary and moving images can be projected on the outer skin, can be fastened to the outer skin, in particular to the vehicle roof or in the outside mirrors. The video projectors have a very small design in this case and are designed as short distance projectors due to the short projection distance (also termed wide-angle or short-throw projector) that allow projection from a short distance and at a sharp angle. In doing so, projection parameters such as the brightness or color temperature of the projected content can be adapted based on sensor data of the vehicle like the current brightness, the presence of daylight or also the vehicle speed of a driving vehicle. Likewise, projection can for example only occur when, under the given light conditions, a clear recognition of the projected content by third parties exists in order to prevent unnecessary energy consumption under unfavorable light conditions.

The invention can be used for any vehicles, without limitation, for example such that have one or more externally affixed display units, or respectively an electronic display directly integrated in the outer skin of the vehicle.

### REFERENCE NUMBER LIST

11 Activation of vehicle-external data display
12 Selection of the data to be shown
13 Reception of data
14 Detection of vehicle state
15 Vehicle-external depiction of data
16 Transmission of parameters on the depiction that occurred
21 Creation of the individual design of the outer skin
22 Check whether conformity has been met
23 Output of notification of nonfulfillment
24 Individualized adaptation of outer skin
31 Group of people
32 Leg wear
33 Shuttle vehicle
34 Bottom part of the outer skin of the shuttle vehicle
41 Generating/receiving unit
42 Control unit
43 Outer skin/display unit

The invention has been described in the preceding using various exemplary embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The mere fact that certain measures are recited in mutually different dependent claims or embodiments does not indicate that a combination of these measured cannot be used to advantage. Any reference signs in the claims should not be construed as limiting the scope.

What is claimed is:

1. A method for a vehicle-external display for a vehicle, and/or for adapting a vehicle-external visual appearance of the vehicle, wherein
data for the vehicle-external display and/or the adaptation of the vehicle-external visual appearance are generated in the vehicle or received by the vehicle; and
using the generated or received data, an individual adaptation is carried out of the vehicle-external visual appearance and/or an individualized vehicle-external display of the data.

2. The method according to claim 1, wherein the vehicle-external display of the data is accomplished using an electronically controlled display unit that is integrated in the outer skin of the vehicle, or is a part of the outer skin of the vehicle, or is designed as an external lighting element.

3. The method according to claim 2, wherein:
a stoppage of the vehicle is detected;
the display unit of the motor vehicle is activated for showing vehicle-external data; and
the activated display unit shows vehicle-external data.

4. The method according to claim 3, wherein the activated display unit shows vehicle-external data when it is detected that the vehicle is in a parked state.

5. The method according to claim 1, wherein the vehicle is an autonomously driving vehicle, and at least part of the outer skin of the vehicle is adapted when the autonomously driving vehicle is requested by at least one future passenger for a transport service.

6. The method according to claim 1, wherein an individualized design of the outer skin of the vehicle is generated within the vehicle using a computer platform or is received by the vehicle, and the outer skin of the vehicle is correspondingly adapted to the individualized design.

7. The method according to claim 1, wherein advertising content is reproduced by adapting the vehicle-external visual appearance, and/or the vehicle-external display, and a parameter is output by the vehicle for the advertising content that has actually been reproduced for a payment system for the reproduction of advertising content.

8. The method according to claim 7, wherein the vehicle is driven by electrical energy provided by a battery, and advertising content is reproduced while charging the battery.

9. A device for a vehicle-external display for a vehicle, and/or for adapting a vehicle-external visual appearance of the vehicle, comprising:
a generating/receiving unit for generating data for the vehicle-external display and/or the adaptation of the vehicle-external visual appearance within the vehicle, or for receiving the data;
a control unit that is fed the generated or received data, wherein the control unit is configured to initiate an individualized adaptation of the vehicle-external visual appearance and/or an individualized vehicle-external display of the data; and
an electronically controllable display/outer skin unit.

10. A motor vehicle that is configured to execute the method according to claim 1.

11. A motor vehicle that comprises a device according to claim 9.

12. The method according to claim 2, wherein the vehicle is an autonomously driving vehicle, and at least part of the outer skin of the vehicle is adapted when the autonomously driving vehicle is requested by at least one future passenger for a transport service.

13. The method according to claim 3, wherein the vehicle is an autonomously driving vehicle, and at least part of the outer skin of the vehicle is adapted when the autonomously driving vehicle is requested by at least one future passenger for a transport service.

14. The method according to claim 4, wherein the vehicle is an autonomously driving vehicle, and at least part of the outer skin of the vehicle is adapted when the autonomously driving vehicle is requested by at least one future passenger for a transport service.

15. The method according to claim 2, wherein an individualized design of the outer skin of the vehicle is generated within the vehicle using a computer platform or is received by the vehicle, and the outer skin of the vehicle is correspondingly adapted to the individualized design.

16. The method according to claim 3, wherein an individualized design of the outer skin of the vehicle is generated within the vehicle using a computer platform or is received by the vehicle, and the outer skin of the vehicle is correspondingly adapted to the individualized design.

17. The method according to claim 4, wherein an individualized design of the outer skin of the vehicle is generated within the vehicle using a computer platform or is received by the vehicle, and the outer skin of the vehicle is correspondingly adapted to the individualized design.

18. The method according to claim 5, wherein an individualized design of the outer skin of the vehicle is generated within the vehicle using a computer platform or is received by the vehicle, and the outer skin of the vehicle is correspondingly adapted to the individualized design.
